SEQUENCE LISTING (2 sequences)

SEQ ID NO: 1 - DNA, 16 bp, Artificial Sequence
  Description of Artificial Sequence  Synthetic Primer
aggtcgccgccctttt

SEQ ID NO: 2 - DNA, 16 bp, Artificial Sequence
  Description of Artificial Sequence  Synthetic Primer
gggcggcgaccttttt

(19) United States
(12) Patent Application Publication
(10) Pub. No.: US 2004/0100893 A1
(43) Pub. Date: May 27, 2004

(54) Data storage medium

(75) Inventors: Willem Andrgas Germishuizen, Chefstroom (ZA); Anton Peter Jacob Middelberg, Cottenham (GB); Alexander Giles Davies, Adel (GB); Michael Pepper, Cambridge (GB); Christoph Walti, Cambridge (GB)

Correspondence Address: Michael C. Barrett, Esq., FULBRIGHT & JAWORSKI, L.L.P., Suite 2400, 600 Congress Avenue, Austin, TX, 78701, US

(73) Assignee: Cambridge University Technical Services Limited

(21) Appl. No.: 10/601,067

(22) Filed: Jun. 20, 2003

(30) Foreign Application Priority Data
Oct. 9, 2002 (GB) 0223481.3

(51) Int. Cl. G11B 7/00; G11B 9/00

(52) U.S. Cl. 369/108; 369/126

(57) ABSTRACT

A representative data storage medium includes: a substrate; and a plurality of elongate, carrier molecules anchored to the substrate. Each carrier molecule carries one or more luminescent groups and is alterable between a readable conformation in which the luminescent groups carried by the molecule are able to emit radiation and an inactive conformation in which the luminescent groups carried by the molecule are inhibited from emitting radiation. A writer to and reader of the data storage medium are also disclosed.

This application claims priority to, and incorporates by reference, UK Patent Application No. 0223481.3, which has a filing date of 9 Oct. 2002.

### BACKGROUND OF THE INVENTION

1. Field of the Invention

THE PRESENT INVENTION relates to a data storage medium and, in particular, an optical data storage medium in which radiation emitting luminescent groups are carried by a plurality of elongate molecules. The invention also relates to a writer to and a reader of such a data storage medium. The present invention also relates to a method of immobilising long or large elongate molecules, such as DNA, to a surface.

2. Description of Related Art

A great number of electronically accessible data storage media are known in the art. For example, single layer optical data storage media such as “compact discs” are used for storing data at a density of around 1 Mb per mm². Typically such single layer optical storage media comprise a disc on one surface of which are formed a plurality of concentric tracks consisting of a series of pits in the surface. Data are stored on the disc as a sequence of digitally encoded pits. In order to read the data stored on the disc, laser light is directed over a track contacting the sequence of pits. By detecting the interference of the laser light reflected from the pits, the sequence of pits can be determined and the data read. The problem with such single layer optical data storage devices is that the size of each pit is limited to being between around 0.4 μm and 1 μm in size because this is approximately the wavelength of a practical laser light directed at the pits. If the pits were smaller than this it would not be possible to resolve whether or not a pit was present in the tracks by means of the reflected laser light. Thus the effective limit of the data storage density possible with such single layer optical data storage devices is dictated by the wavelength of laser light directed at the track.

It has also been proposed to provide multiple layer optical data storage media. An example of a multiple layer optical data storage medium comprises a substantially transparent card comprising ten layers. Each layer is provided with a separate track consisting of a series of coloured wells whose function approximately corresponds to the pits of the single layer optical data storage medium described above. Thus data is stored in the medium by the position of the wells within each track. The wells in each layer of the card are of a different colour and when reading the data, laser light of each of the ten colours is directed at the card. If the colour of the laser light is the same as the colour of the wells of the first layer on which it is incident and a well is present then light of a particular wavelength is reflected back by the well. If the laser light is of a colour different from that of the well, or a well is not present then the light passes through the first layer on to the second layer where the same process can occur. The process is repeated through all of the layers of the card. Thus it is possible to determine the sequence of coloured wells in each of the ten layers of the card and therefore determine the data encoded by each of the tracks. Such a medium allows a data storage density of approximately 11 Mb per mm². However, as with the single layer optical data storage medium, the problem with multiple layer optical data storage media is that the size of the coloured wells is still limited by the wavelength of incident laser light to being no less than around 1 μm. Furthermore, there is a practical limit to the number of layers that can be provided in such a medium because if the number of layers is too great then the intensity of the light reflected by the wells in the layer furthest from the incident laser light is too low to be detected. Thus there is still an effective limit as to the data density recordable in such devices, dictated by, amongst other factors, the wavelength of laser light used.

It is also known in the art, such as is disclosed in U.S. Pat. No. 5,787,032, to form a 3-dimensional optical data storage medium using chromophore marked DNA oligonucleotides. Such a medium typically comprises a substrate to which are attached an array of units of DNA oligonucleotides. Arranged along the length of each DNA oligonucleotide are one or more chromophore groups. Typically each chromophore group comprises a donor group, an acceptor group and a quencher group, the quencher group being switchable between an active and an inactive state by illumination with ultraviolet light. If the quencher group of a particular chromophore group is inactive then, in response to incident light, the donor and acceptor groups of the chromophore group emit light when excited that may be detected. However, if the quencher group is active then the donor and acceptor groups of the chromophore group do not emit light in response to illumination. Accordingly, the presence or absence of active quencher groups in each chromophore group provides a means for readably encoding data in the medium.

In some versions of this type of data storage medium, different kinds of chromophore groups are provided, for example, groups which emit light of different wavelength, intensity or polarisation under incident light of the same type. Thus data is encoded in the medium by the arrangement of different types of chromophore groups within each unit. Since a mixture of different types of chromophores may be provided, each unit of DNA oligonucleotides forming the array may contain more than one bit of information. However, the problem with such chromophore marked DNA 3-dimensional optical data storage media is the same as in the previously described media, namely that the smallest unit of data storage is still limited by the wavelength of laser light directed at the array. Thus the unit size can be no smaller than around 1 μm for data to be read.

### SUMMARY OF THE INVENTION

The present invention seeks to alleviate the above problems.

According to the present invention there is provided a data storage medium comprising: a substrate; and a plurality of elongate carrier molecules anchored to the substrate, each carrier molecule carrying one or more luminescent groups and being alterable between a readable conformation in which the luminescent groups carried by the molecule are able to emit radiation and an inactive conformation in which the luminescent groups carried by the molecule are inhibited from emitting radiation.

Contextually, it is to be understood that the one or more luminescent groups being carried by the elongate carrier molecules become readable as a result of the structure, orientation or conformation of the elongate carrier molecules being manipulated, such manipulation based on a physical or chemical property of same, such that as a result of such change the luminescent groups are able to emit radiation, as a result of being distanced from an agent, such as a quenching agent, which will inhibit or prevent the luminescent groups from emitting radiation and/or as a result of being exposed to a source of radiation that will lead to the emission of radiation.

Conveniently each of the plurality of elongate carrier molecules is associated with one or more quencher groups located such that when each molecule is in the inactive conformation, the or each quencher group renders the luminescent group of the molecule inactive.

Preferably the distance between the or each quencher group and each luminescent group carried by the associated elongate carrier molecule when in the readable conformation is at least 50 nm.

Advantageously the distance between the or each quencher group and each luminescent group carried by the associated elongate molecule when in the inactive conformation is less than 50 nm.

Conveniently the or each quencher group is carried by its associated elongate carrier molecule.

Preferably the quencher groups are provided substantially adjacent the substrate.

Advantageously the elongate carrier molecules are carrier oligonucleotides and the or each quencher group is attached to its respective carrier oligonucleotide via an attachment oligonucleotide having a sequence complementary to a sequence of the respective carrier oligonucleotide.

Conveniently the or each quencher group is carried by the substrate.

Preferably fewer than ten quencher groups per luminescent group are associated with each elongate, carrier molecule.

Advantageously one or two quencher groups per luminescent group are associated with each elongate, carrier molecule,

Conveniently five to ten quencher groups per luminescent group are associated with each elongate, carrier molecule.

Preferably at least one of said one or more quencher groups is able to quench incident light on adjacent luminescent groups when their associated elongate, carrier molecule is in the inactive conformation.

Conveniently at least one of said one or more quencher groups is able to quench light from being emitted from adjacent luminescent groups when their associated elongate, carrier molecule is in the inactive conformation.

Preferably the substrate has luminescent group quenching properties such that when the elongate, carrier molecule is in the inactive conformation, the substrate renders inactive the luminescent group or groups carried by the molecule.

Advantageously the substrate is made from a metal.

Conveniently the metal comprises gold.

Preferably the conformation of the elongate, carrier molecule in the inactive conformation inhibits the luminescent group or groups carried by the molecule.

Advantageously the substrate is a plasmon transmitting substrate.

Conveniently said one or more luminescent groups are located less than 5 nm from the substrate when their respective elongate carrier molecule is in the inactive conformation.

Preferably said one or more luminescent groups are located between 20 and 100 nm from the substrate when their respective carrier molecule is in the readable conformation.

Conveniently the elongate, carrier molecules are carrier polymers.

Advantageously the carrier polymers are organic carrier polymers.

Conveniently the carrier polymers are carrier oligonucleotides.

Preferably the carrier oligonucleotides are carrier DNA oligonucleotides.

Advantageously said one or more luminescent groups are attached to their respective carrier oligonucleotide via an attachment oligonucleotide having a sequence complementary to a sequence of the respective carrier oligonucleotide.

Conveniently each carrier oligonucleotide is anchored to the substrate by an intermediating linker oligonucleotide, the linker oligonucleotide being anchored to the substrate and comprising a nucleotide sequence complementary to a sequence of the carrier oligonucleotide such that said sequences form a duplex, binding the carrier oligonucleotide to the linker oligonucleotide.

Preferably the organic carrier polymers are carrier polypeptides.

Advantageously said polypeptide comprises an α-helix domain.

Conveniently said polypeptide comprises a β-sheet domain.

Preferably said polypeptide comprises a flexible loop.

Advantageously each elongate, carrier molecule is movable between the readable and inactive conformations under the influence of an electric field.

Conveniently the electric field is positive.

Preferably the electric field is negative.

Advantageously the electric field is alternating.

Conveniently the electric field alternates at a frequency of up to 10 MHz.

Preferably the electric field alternates at a frequency of from 10 kHz to 1 MHz.

Advantageously each elongate, carrier molecule is movable between the readable conformation and the inactive conformation under the influence of a magnetic field.

Conveniently the alteration of an elongate, carrier molecule between the inactive conformation and the readable conformation comprises a stretch, flip, fold or rotation thereof.

Preferably each elongate, carrier molecule carries a plurality of distinguishable luminescent groups.

Advantageously each elongate, carrier molecule carries four distinguishable luminescent groups.

Conveniently each elongate, carrier molecule carries one or more groups carrying an electrical charge.

Preferably said one or more luminescent groups each comprises one or more luminophores.

Advantageously said one or more luminescent groups each comprises one or more semiconductor nanocrystals.

Conveniently said emitted radiation and/or the radiation to which the luminescent groups are responsive is visible radiation.

Preferably said emitted radiation and/or the radiation to which the luminescent groups are responsive has a wavelength of from 0.70 to 1.5 μm.

Adventageously, said emitted and/or the radiation to which the luminescent groups are responsive has a wavelength of from 0.2 μm to 0.4 μm.

According to another aspect of the present invention there is provided a writer for a data storage medium incorporating a plurality of elongate, carrier molecules each capable of carrying one or more luminescent groups and being alterable between a readable conformation and an inactive conformation, the writer comprising: a plurality of luminescent groups selectively attachable to each elongate, carrier molecule.

Conveniently the elongate, carrier molecules are carrier oligonucleotides and each luminescent group comprises an attachment oligonucleotide having a sequence complementary to at least a portion of the sequence of one or more of the carrier oligonucleotides.

Preferably the writer further comprises a probe capable of effecting an alteration of one or more selected elongate, carrier molecules of the data storage medium from the inactive to the readable conformation, the luminescent groups being attachable to elongate, carrier molecules in the readable conformation but unattachable to elongate, carrier molecules in the inactive conformation.

According to another aspect of the present invention there is provided a method of writing to a data storage medium incorporating a plurality of elongate, carrier molecules each capable of carrying one or more luminescent groups and being alterable between a readable conformation and an inactive conformation, comprising the steps of:

selectively attaching luminescent groups to each elongate, carrier molecule.

Conveniently the step of selectively attaching luminescent groups comprises activating a selected elongate, carrier molecule to increase the attachability of luminescent groups to the elongate, carrier molecule and providing luminescent groups to the medium such that they attach to the activated elongate, carrier molecule.

Preferably the step of activating the selected elongate, carrier molecule comprises altering the molecule from its inactive to its readable conformation.

According to a further aspect of the present invention there is provided a writer for a data storage medium incorporating a plurality of elongate, carrier molecules each carrying one or more luminescent groups having a first operative state and being alterable between a readable conformation and an inactive conformation, the writer comprising:

means for switching the operative state of selected luminescent groups to a second operative state.

Conveniently in the first operative state the luminescent groups are operative and in the second operative state the luminescent groups are inoperative.

Preferably the writer further comprises means for write-enabling selected luminescent groups, the means for switching the operative state of selected luminescent groups being effective only on write-enabled luminescent groups.

Advantageously the means for write-enabling selected luminescent groups comprises a probe capable of effecting alteration of one or more selected elongate, carrier molecules from the inactive to the readable conformation.

Conveniently the means for switching the operative state of selected luminescent groups to a second operative state comprises a redox state altering enzyme.

Preferably the means for switching the operative state of selected luminescent groups to a second operative state comprises a photobleacher.

Advantageously the writer further comprises means for switching the operative state of selected luminescent groups to the first operative state.

According to yet another aspect of the present invention there is provided a method of writing to a data storage medium incorporating a plurality of elongate carrier molecules, each carrying one or more luminescent groups having a first operative state and being alterable between a readable conformation and an inactive conformation, comprising the steps of:

selectively switching the operative state of selected luminescent groups to a second operative state.

Conveniently in the first operative state the luminescent groups are operative and in the second operative state the luminescent groups are inoperative.

Preferably the method further comprises the step of write-enabling one or more selected elongate, carrier molecules, prior to switching the operative state of the write-enabled molecules.

Advantageously the step of write-enabling one or more selected elongate, carrier molecules comprises altering the molecule from the inactive to the readable conformation.

Conveniently the step of switching the operative state of selected luminescent groups comprises altering the redox state, or quantum yield of the luminescent groups.

Preferably altering the redox state of the luminescent groups comprises providing a redox-state altering enzyme.

Advantageously altering the quantum yield of the luminescent groups comprises providing a photobleacher.

Conveniently the method further comprises the step of selectively switching the operative state of selected luminescent groups to the first operative state.

According to another aspect of the present invention there is provided a reader for a data storage medium incorporating a plurality of elongate, carrier molecules, each carrying one or more luminescent groups and being alterable between a readable conformation and an inactive conformation, the reader comprising:

a probe capable of effecting an alteration of one or more selected elongate, carrier molecules of the data storage medium from the inactive to the readable conformation.

Conveniently the reader further comprises:

a radiation source directable on the data storage medium; and

a detector for detecting radiation emitted by the luminescent groups.

Preferably the radiation source is a light source, of visible radiation.

Advantageously the radiation source is a source of radiation having a wavelength of between 0.70 and 1.5 μm.

Preferably the radiation source is a source of radiation having a wavelength of between 0.2 μm and 0.4 μm.

Conveniently the plurality of elongate, carrier molecules are anchored to a substrate and the radiation source comprises an evanescent field generator.

Preferably the substrate is substantially planar, the plurality of elongate, carrier molecules being anchored to one side of the substrate, and the evanescent field generator is directable on the other side of the substrate.

In another preferred embodiment, the substrate is in the form of at least one set of oppositely facing electrodes.

Advantageously the reader comprises a plurality of radiation sources and/or detectors.

Conveniently wherein the reader comprises a plurality of probes.

Preferably the or each probe is operable to carry an electrical charge.

Advantageously the electric charge is positive direct current.

Conveniently the electric charge is negative direct current.

Preferably the electric charge is alternating.

Advantageously wherein the electric charge alternates at a frequency of up to 10 MHz.

Conveniently the electric charge alternates at a frequency of from 10 kHz to 1 MHz.

Preferably the or each probe is capable of effecting alteration of the one or more selected carrier polymers from the inactive to the readable conformation over an area of less than 100 nm².

According to a further aspect of the present invention there is provided a method of reading a data storage medium incorporating a plurality of elongate, carrier molecules, each carrying one or more luminescent groups and being alterable between a readable conformation and an inactive conformation, comprising the step of effecting an alteration of one or more selected elongate, carrier molecules of the data storage medium from the inactive to the readable conformation.

Conveniently the method further comprises the steps of directing radiation on the one or more selected elongate, carrier molecules and detecting radiation emitted by the luminescent groups.

Preferably the step of effecting an alteration of one or more selected elongate, carrier molecules comprises stretching, flipping, folding or rotating the molecule.

### BRIEF DESCRIPTION OF THE DRAWINGS

In order that the invention may be more readily understood and so that further features thereof may be appreciated, embodiments thereof will now be described, by way of example, with reference to the accompanying drawings in which:

FIG. 1 is a schematic view of a data storage medium according to a first embodiment of the present invention, in use;

FIG. 2 is a pictorial view of a portion of the data storage medium shown in FIG. 1;

FIG. 3 is a pictorial view of a portion of the data storage medium in accordance with another embodiment of the invention; and

FIG. 4 is a pictorial view of a portion of the data storage medium in accordance with a third embodiment of the invention.

FIG. 5 is a schematic diagram showing the multistep procedure used to immobilise λ-DNA on the gold electrodes. Biotin is indicated by ‘B’ and thiol by ‘S’. (a) Gold electrodes were coated with a monolayer of hybridised double-stranded oligonucleotides XY, followed by (b) immersing in MCH to block the surfaces not covered by XY and to orientate the oligonucleotides upwards. (c) Oligonucleotide Y was dissociated by heating to 70° C. (d) λ-DNA was then hybridised and subsequently ligated to the surface-bound oligonucleotide X.

FIG. 6 is a schematic view of the microelectrode setup used. The laser-beam is focused and directed into the channel for the laser-beam, which is indicated in the drawing. Figures b)-d) are enlargements of the centre area of the electrode array indicated by the dotted line.

FIG. 7 is a length of the elongated λ-DNA upon dielectrophoretic stretching as a function of frequency under a 30 V potential across a 30 μm gap. The λ-DNA was immobilised onto the gold electrodes using the multistep procedure and the length of the DNA was determined by measuring the distance between the electrode edge and the end of the fluorescence band. The data represent an average of three measurements and the error bars indicate the standard deviation.

FIG. 8 is a fluorescence image of an array of five gold electrodes at the beginning of the writing step. The λ-DNA on the first and third electrode is selectively stretched into the 10 Mw laser beam by a 1 MV/m, 400 kHz ac electric field to be photobleached. The photobleaching was complete after 30 min thus leading to a stored binary pattern 10100. The image was acquired with a cooled CCD camera with a 525 nm bandpass filter.

FIG. 9 is a schematic diagram of the optical setup suitable for use with the fourth embodiment. The beam of a 5 W argon ion laser is attenuated with a neutral density filter (N1) and the 488 nm line was selected with a bandpass filter. The light is coupled into an optic fibre and focused into the groove on the wafer between the electrodes with a gradient-index micro lens (GR). At the other end of the groove, the light is collected with a second GR, coupled into a second fibre and the intensity measured with a silicon photodiode (Si PD). The fluorescence emission perpendicular to the surface was collected with a microscope like combination of a 10× eyepiece and 20× objective, filtered, and its intensity measured with a silicon avalanche photodiode (APD).

### DESCRIPTION OF ILLUSTRATIVE EMBODIMENTS

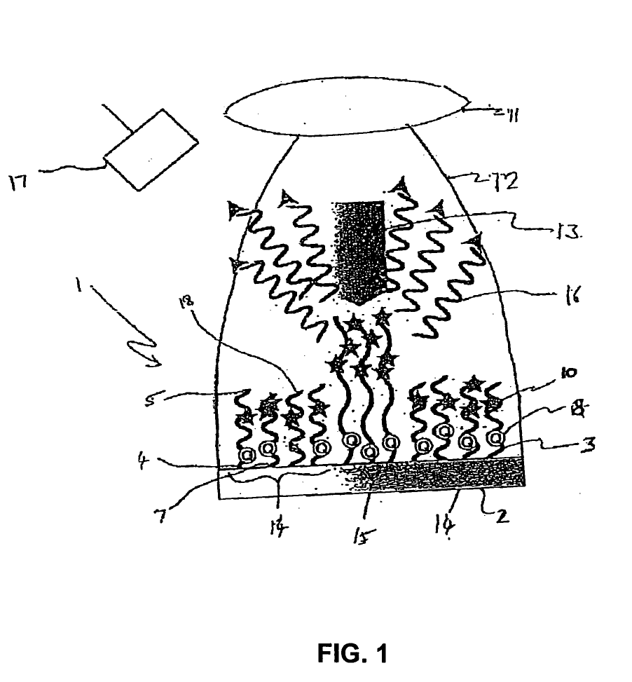

Referring to FIG. 1, the data storage medium 1 comprises a flat, substantially planar substrate 2 on which are bonded an array of single-stranded carrier DNA oligonucleotides 3 forming a plurality of units. Each carrier oligonucleotide 3 has first and second ends 4, 5 and is bonded at its first end 4 to the flat substrate 2 by the provision of a sulphur atom 6 at the first end of the carrier oligonucleotide. The substrate is preferably manufactured from a gold coated substrate, on a silanised glass substrate derivatised with activated disulphide groups, to which the sulphur atoms readily adhere. In other embodiments, the carrier oligonucleotide 3 is bonded to the substrate 2 other than by the sulphur atom 6. For example, the carrier oligonucleotide 3 is bonded to the substrate 2 by a metal chelate or polymer in some embodiments.

In other embodiments of the invention, the carrier oligonucleotides are not bonded directly to the flat substrate 2. Instead, an array of short, single-stranded linker DNA oligonucleotides 7 are bonded to the flat substrate 2, at a first end. The second end of each linker oligonucleotide 7 is bonded to a respective carrier oligonucleotide 3 having a corresponding sequence, by the standard Watson-Crick base-pairing to form a DNA duplex. In such embodiments (see oligonucleotide 3 having a linker oligonucleotide 7) it is possible to manufacture sets of standardised components comprising the flat substrate 2 and an array of linker oligonucleotides 7 which can then be customised by attachment of the required carrier oligonucleotides 3.

In the event that it is preferable to use large carrier molecules, for example, large thiolated DNA molecules, it may prove difficult to immobilise them onto the substrate. The reason being is that long DNA molecules assume a random coil conformation and, as such, since the sulphur group at one end of the DNA molecule is unlikely to come into close enough proximity with the gold-surface to form a bond, attachment of the molecules using known immersion protocols [for which see Steel A B, Levicky R L, Heme T M and Tarlov M J 2000 Biophys. J 79 975Levicky R L, Heme T M, Tarlov M J and Satija S K 1998 J. Am. Chem. Soc. 120 9787; the contents of which are incorporated herein by reference thereto] can prove problematic.

However, with a view to addressing the problem of immobilising large thiolated DNA molecules to the substrate, the Applicants have devised a multi-step procedure, the details of which are described hereinbelow:

As will be appreciated, λ-DNA is a long (48.5 kilobase pairs), double-stranded, circular DNA molecule, which has two single-strand nicks in the backbone, twelve bases apart. The circular conformation is maintained through these twelve Watson-Crick base pairs, which dissociate upon heating to produce a linearised DNA molecule with two single-stranded complementary ends, each twelve bases long. Thiolated λ-DNA will not adsorb directly from solution, even after 48 hr incubation. As touched upon above, linearised λ-DNA adopts a random-coil conformation in solution thereby reducing the probability of thiol-gold contact.

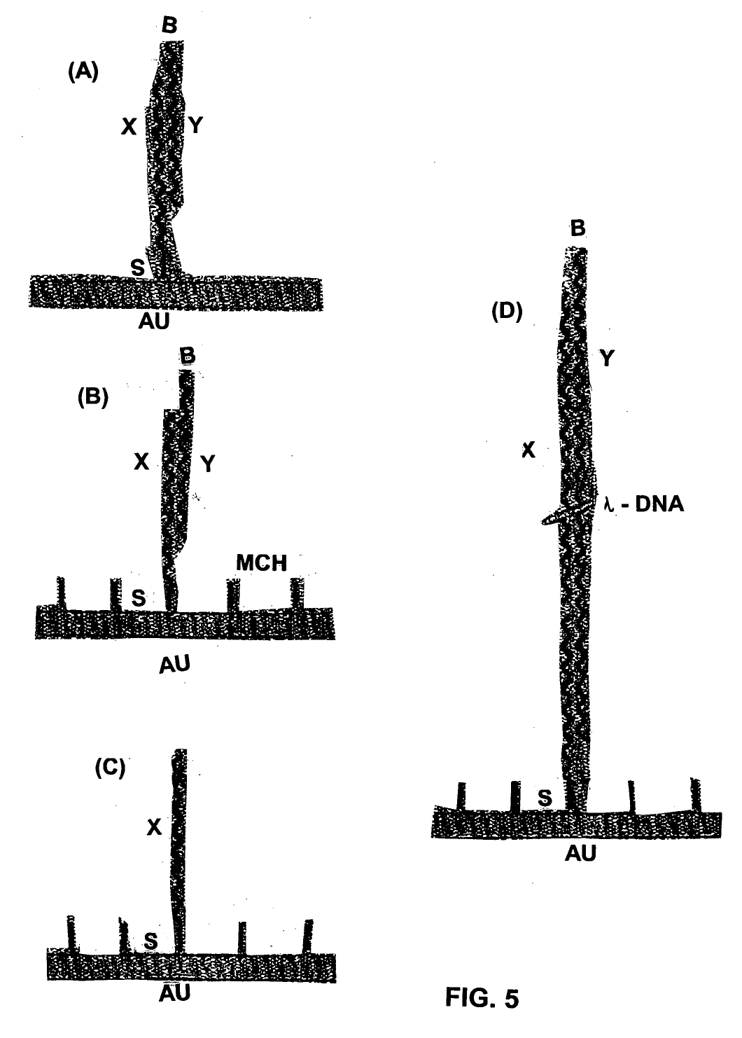

As illustrated in FIG. 5, the multi-step immobilisation procedure involves the use of first and second oligonucleotides. The first of such oligonucleotides is a thiolated oligonucleotide, herein designated X, of sequence 5′-AGGTCGCCGCCCTTTT-thiol-3′. Apart from the four T spacers in X, its sequence is complementary to one of the single-stranded ends of the λ-DNA. The second oligonucleotide is a biotinylated oligonucleotide, herein designated Y, of sequence 5′-GGGCGGCGACCTTTTT-Biotin-3 ′. Apart from the four T spacers, Y is complementary to X and therefore, also complementary to the second λ-DNA end. Both oligonucleotides are 5′-phosphorylated and can be purchased from MWG, Munich.

The first and second oligonucleotides are first hybridised to form a double-stranded molecule, XY. This can be done in a 40 μl solution by adding 2 μl X (0.5 μM) and 2 μl Y (0.5 μM) to 36 μl×TE (10 mM Tris-HCl, 1 mM NaCl, 1 mM EDTA, pH 7.5), 1 M NaCl and incubating at 25° C. for 1 h.

The hybridised oligonucleotides can then be added to the substrate. This can be done by placing 2 μl droplet of this solution on to the substrate. The solution and substrate can then be incubated in a humid compartment at room temperature for 2 h during which the thiolated DNA will be adsorbed to the gold and become bound through the strong thiol-gold covalent bond (see FIG. 5(a)). To remove unbound oligonucleotide the substrate can be rinsed in deionised water for 5 min and then immersed in a 1 mM 6-mercapto-1-hexanol (MCH) solution for 1 h to block any regions of the substrate not coated with XY (see FIG. 5(c)).

The oligonucleotides Y are then dissociated from the surface-bound oligonucleotides X. This can be done by placing the substrate in a 70° C. waterbath for 10 min. It can then be subsequently rinsed in deionised water (see FIG. 5(c)).

Each step in this immobilisation procedure, as the Applicants have done, can be separately validated on gold-coated microscope slides, using a biotin antibody immunodetection method that identifies the presence of the biotin on oligonucleotide Y [see Wirtz R, Walti C, Germishuizen W A, Pepper M, Middelberg A P J and Davies A G 2003 Nanotechnol. 14 9; the contents of which is incorporated herein by reference thereto]. The biotin can be detected by binding to a biotin antibody conjugated with alkaline phosphatase, which results in a colour change to dark blue when the antibody is stained using a solution of a Sigma Fast™ BCIP/NBT in deionised water. The colour change can be quantified by measuring the reflectivity of the gold surface with a Perkin Elmer LS-50 luminescence spectrometer at 435 nm—higher surface coverage of biotinylated DNA leads to lower reflectivity of the gold surface after the immunodetection procedure (see Wirtz R, Walti C, Germishuizen W A, Pepper M, Middelberg A P J and Davies A G 2003 Nanotechnol. 14 9; the contents of which is incorporated herein by reference thereto). By measuring the extent of XY adsorption for different incubation times by this technique, the Applicants were able to establish that maximum surface coverage was achieved after 2 h. Adsorption of XY was significantly reduced when the gold surface was previously covered by a MCH monolayer. This confirms that the MCH blocks DNA binding to gold. In addition, after the gold surface carrying the immobilised XY was incubated at 70° C. for 10 min, a subsequent immunodetection procedure revealed that no biotin on remained on the surface. This demonstrating that the biotinylated oligonucleotide Y had been removed.

The λ-DNA nucleotiedes were then linearised. This can be done as follows:

One microlitre of a 1 μg/μl solution of λ-DNA was added to 9 μl 1×TE, 1 M NaCl and heated for 10 min to 65° C. to linearise the molecules. To prevent the λ-DNA returning to its circular conformation, 2 μl of Y was added to hybridise to the λ-DNA upon cooling.

The λ-DNA was then labelled. In this connection, the linearised λ-DNA was labelled with a fluorescent intercalator, we used YOYO-1 (Molecular Probes), by adding 2 μl of a solution of 2 μl YOYO-1 in 18 μl phosphate buffer (1.5 M KH₂PO₄, pH 6.8) and incubating at 25° C. for 10 min. Unincorporated dye molecules and oligonucleotides were then removed using a Microspin-400 column (Amersham Pharmacia Biotech). This corresponds to a molar ratio of intercalator to DNA base pairs of 1:8.

The labelled λ-DNA MOLECULES Were then added to the substrate. This can be done as follows:

Two microlitres of the fluorescently-labelled λ-DNA solution can then be applied to the substrate and incubated in a humid compartment at room temperature for 12 h to allow the remaining single-stranded end of the λ-DNA to hybridise to the surface-bound oligonucleotide X (see FIG. 5(d)). The substrate surface can then be rinsed in deionised water for 5 min. The surface-bound oligonucleotide X and the λ-DNA can be ligated to form a single molecule by applying 2 μl of a solution containing 1 μl 10× ligation buffer and 1 μl ligase (New England Biolabs) in 8 μl deionised water, and incubating the substrate in a humid chamber for another 2 h at room temperature, followed by a final rinsing step with deionised water. Thereafter the substrate can be kept submerged in deionised water. This hybridisation and ligation process can be verified by placing the wafer in a 70° C. waterbath for 10 min after which only ligated λ-DNA is expected to remain on the surface. In this connection, the immunodetection procedure revealed the presence of Y when ligase was added, but not when the ligase was omitted.

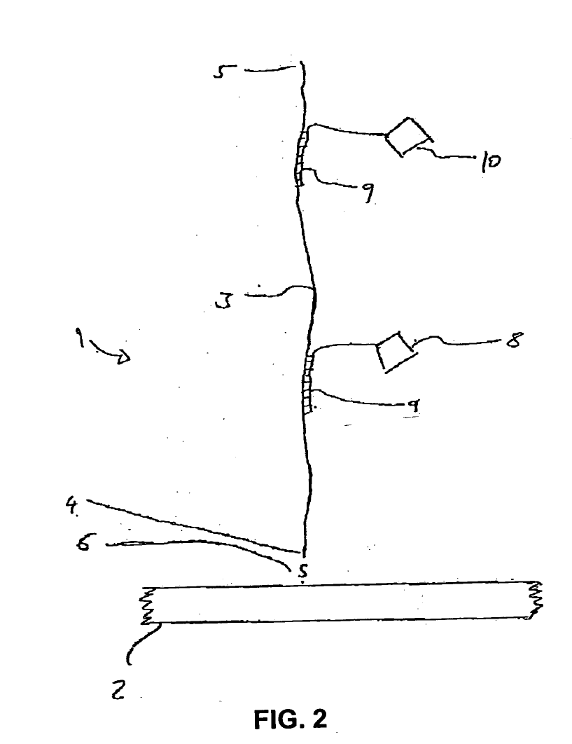

Referring now to FIG. 2, and as shown schematically in FIG. 1, each carrier oligonucleotide 3 is provided, adjacent its first end 4, with a quencher group 8. The quencher group 8 is attached to the carrier oligonucleotide 3 by way of a single-stranded attachment DNA oligonucleotide 9 which has a sequence complementary to the sequence of the portion of the carrier oligonucleotide 3 to which it is attached to form a DNA duplex. Thus, during manufacture of the data storage medium 1, the position of each quencher group 8 along the carrier oligonucleotide 3 is determined by the position of the sequence on the carrier oligonucleotides 3 that is complementary to the sequence of the attachment oligonucleotide for the quencher groups.

Further along each carrier oligonucleotide 3, in the direction towards its second, free end 5, there are provided one or more luminophore groups 10. The luminophore groups 10 are bonded to their respective carrier oligonucleotide 3 in a similar manner as for the quencher groups 8. Accordingly, a single-stranded attachment DNA oligonucleotide 9 having a DNA sequence complementary to the corresponding portion of the carrier oligonucleotide 3 is attached to the luminophore group and bonds by Watson-Crick base-pairing to the carrier oligonucleotide 3 to form a DNA duplex. Each luminophore group 10 comprises a donor and acceptor group located between around 1 and 10 nm from each other. The donor group can absorb radiation of a predetermined wavelength and non-luminescently transfer the energy to the acceptor group. In response to this, the acceptor group emits radiation of a wavelength different from that absorbed by the donor group. Thus the donor and acceptor groups are capable of resonant energy transfer. In some other embodiments the luminophore group 10 comprises a single group, such as a luminescent molecule, that can absorb incident radiation of a particular wavelength and emit radiation of a different wavelength. In some embodiments, the luminophore groups emit electromagnetic radiation having the wavelength of visible radiation, i.e. light. The carrier oligonucleotides 3 carry a range of different types of luminophore groups 10, each type responsive to incident radiation of a different wavelength and/or emitting a different wavelength of radiation in response to incident light.

Luminescence is the spontaneous emission of radiation from an excited species not in thermal equilibrium with its environment. Accordingly, a luminophore is a luminescent material or species that emits radiation by absorbing and converting a portion of incident energy. Thus the term “luminophore” includes fluorophores and chromophores.

In some alternative embodiments, a luminescent group other than a luminophore group 10, such as a semiconductor nanocrystal, is provided. However, the effect is the same, namely to emit radiation in response to incident radiation.

Data is encoded in the optical data storage medium by the arrangement and selection of luminophores 10 on the carrier oligonucleotides 3 in a particular unit of the array. Thus, as a very simple example, the provision of a luminophore group 10 emitting radiation of a high wavelength on the carrier oligonucleotides 3 of a unit signifies the presence of the binary digit “1” in that unit. The provision of a low wavelength radiation emitting luminophore group 10 signifies the presence of the binary digit “0” encoded in that unit of the array. In preferred embodiments of the invention, a plurality of different types of luminophore can be provided in each unit of the array, each type being responsive to/or emitting a different wavelength of light and therefore being individually distinguishable. In these embodiments, each type of luminophore group in a unit is attached to each carrier oligonucleotide 3 in the unit or, alternatively, different carrier oligonucleotides in the unit carry different types of luminophore. These embodiments allow more than one bit of data to be stored in each unit of the array. For example, if up to four different types of luminophore group are provided in each unit then sixteen different bits of information can be stored in each unit because there are sixteen possible combinations of luminophore group. It is to be appreciated that by encoding data using luminophore groups that are responsive to and/or emit radiation at a number of different wavelengths it is possible to store a large number of bits of information in a single unit of the array.

It is to be understood that in some embodiments of the invention, information may be encoded in the data storage medium 1 in which certain data is signified by the absence of any luminophore groups 10 on the carrier oligonucleotides 3 of a particular unit of the array. However, even in these embodiments of the invention, at least some of the units of the array will be provided with carrier oligonucleotides 3 having at least one luminophore group 10.

The effect of the quencher groups 8 on the luminophore groups 10 is to prevent emission of radiation from the acceptor groups when the quencher groups 8 are spacially adjacent (e.g. less than 50 nm from) the luminophore groups 10. This inhibits the luminophore groups 10 from emitting light in that no light is emitted by the luminophore groups 10 in response to incident light or the responsiveness of the luminophore groups 10 to incident light is reduced to such an extent that it is readily determinable that the luminophore groups are quenched.

In some alternative embodiments of the invention, the quencher group 8 instead absorbs, and thus quenches, incident light from illuminating the luminophore groups 10. In some other embodiments, two quencher groups 8 are attached to each carrier oligonucleotide 3. Preferably one quencher group absorbs incident light, and the other quencher group absorbs light emitted by the luminophore group 10. In some embodiments, one of the pair of quencher groups 8 is attached to the carrier oligonucleotide 3 adjacent its first end 4 and the other of the pair of quencher groups 8 is attached to the carrier oligonucleotide 3 adjacent its second end 5, on the far side of the one or more luminophore groups 10.

Thus there is provided a substrate 2 on which is anchored a plurality of carrier oligonucleotides 3 which form the units of an array. It is to be appreciated that in some embodiments of the present invention there is no need for their to be a physical division between the units of the array, the formation of units being arbitrary for the purpose of reading and writing information to and from the medium. Each carrier oligonucleotide 3 carries one or more quencher group 8 and one or more luminophore groups 10. Data is encoded by the position and type of luminophore groups 10 attached within the array. When the quencher group 8 is spacially adjacent the luminophore groups 10, the luminophore groups' radiating effect is inactivated.

As part of the data storage medium reader mechanism, an optical system 11 is provided, above the array of carrier oligonucleotides 3 which is capable of directing a beam of radiation such as laser light 12 at the array. A probe 13 is also provided, having a diameter of radiation such as around 40 nm. The probe 13 is of the type used in proximal probe microscopes such as atomic force microscopes and scanning, tunnelling microscopes. The probe 13 is movable relative to the array and has a positive electric charge. A detector 17 is also provided above the substrate 2.

It is to be appreciated that the carrier oligonucleotides 3 are flexible polymers and, at rest, the carrier oligonucleotides 3, have a collapsed conformation in which the quencher groups 8 are adjacent the luminophore groups 10 on each carrier oligonucleotide 3 in order to cause quenching of the radiating effect of the luminophore groups 10. These are exemplified by the inactive units 14 of carrier oligonucleotides 3 shown in FIG. 1. Accordingly, at rest, the luminophore groups 10 attached to the carrier oligonucleotides 3 are inactive because illumination by a light beam 12 does not result in emission of radiation from the acceptor groups of the luminophores 10 due to their proximity to the quencher groups 8.

There are two techniques that may be used to write data to the data storage medium 1. Firstly, specific luminophores are located on carrier oligonucleotides 3 at specific units of the array. Secondly the data storage medium 1 is provided with identical luminophore groups 10 all having the same operative states on the carrier oligonucleotides in all units of the array. The operative state of the groups is subsequently selectively switched in order to write data. The “operative state” of a luminophore group refers to it being either operative or inoperative. It is to be appreciated that a luminophore group 10 that is inoperative is unresponsive to incident radiation irrespective of the conformation of the carrier oligonucleotide 3 to which it is attached. An operative luminophore group will also be inactive when the carrier oligonucleotide to which it is attached is in the collapsed conformation but will be responsive to incident radiation of a particular wavelength when the carrier oligonucleotide to which it is attached is in the readable conformation, as is explained in more detail below.

With reference to the first technique for writing information to the data storage medium 1, in one embodiment a blank medium is provided comprising the substrate 2 on which are anchored the plurality of carrier oligonucleotides 3, each carrying a quencher group 8 but no luminophore groups 10. In this embodiment, the DNA sequence of all carrier oligonucleotides in a unit is the same but is different for each unit. The medium 1 is then washed with a solution containing a plurality of luminophore groups 10 of different types, each bonded to an attachment oligonucleotide 9 having a preselected DNA sequence. The DNA sequence of the attachment oligonucleotides 9 is selected such that it is complementary to a portion of the sequence of the carrier oligonucleotides 3 of the unit in which it is to be located in order to encode the data appropriately. The attachment oligonucleotide 9 binds to the carrier oligonucleotide 3 to form a DNA duplex. However, the DNA sequence of the attachment oligonucleotides is also selected such that it is not complementary to the sequences of any other carrier oligonucleotides 3 and does not bind to them. Thus the sequences of the carrier oligonucleotides 3 and the attachment oligonucleotides 9 that are selected result in the luminophore groups 10 being bound in the appropriate units of the array to encode the data. Subsequently, any unbound attachment oligonucleotides 9 and their respective luminophore groups 10 are removed from the medium 1 for example, by subsequent washing.

With further reference to other embodiments of the first technique for writing information to the data storage medium, the attachment oligonucleotides 9, carrying the luminophore groups 10, are annealed to their respective carrier oligonucleotides 3 with some spacial specificity. In particular, in certain embodiments, the collapsed conformation of the carrier oligonucleotides 3 at rest is such that annealing of the attachment oligonucleotides 9 to a carrier oligonucleotide 3 having a complementary sequence to form a DNA duplex is not possible because of steric hindrance from other portions of the carrier oligonucleotide 3.

In this embodiment, the probe 13 is magnetic. Magnetic beads having a diameter of between about 2 and 5 nm are attached to the second end of each carrier oligonucleotide 3 such that when the probe 13 is located to adjacent carrier oligonucleotides 3 in a unit, the magnetic beads are attracted by the probe 13 and the carrier oligonucleotides 3 are stretched. In order to write to a particular unit of the array, the probe 13 is located adjacent unit, thus the probe's magnetic field attracts and stretches the carrier oligonucleotides 3 in the unit. Once the carrier oligonucleotides are stretched, the relevant attachment oligonucleotides 9, bonded to luminophore groups 10, are washed over the medium 1 and anneal only to the stretched carrier oligonucleotides 3 to form a DNA duplex. The attachment oligonucleotides 9 are not attracted by the magnetic field because no magnetic beads are attached to the attachment oligonucleotides 9. Any unbound attachment oligonucleotides 9 and their respective luminophore groups 10 are removed from the medium 1 and the probe 13 is then moved away from the unit so that the carrier oligonucleotides 3 in the unit return to their collapsed conformation. In this way, it is not necessary that the carrier oligonucleotides 3 in each unit of the array have a different nucleotide sequence because the specificity of the attachment of luminophore groups 10 to the carrier oligonucleotides is provided by the influence of the probe 13.

With reference to the second technique for writing information to the data storage medium 1, in one embodiment the substrate 2 is provided with an array of carrier oligonucleotides 3, each carrying identical luminophore groups 10. The luminophore groups 10 are operative in response to incident radiation because of their redox state. In order to write information to a unit of the array, the probe 13 is located adjacent the unit and attracts and stretches the carrier oligonucleotides in the unit. The medium 1 is then washed with a redox-state-altering enzyme. The enzyme alters the redox state of the luminophore groups 10 attached to the stretched carrier oligonucleotides 3 in the unit, switching the operative state of those luminophore groups 10 so that they are inoperative. However, the carrier oligonucleotides 3 in the other units of the array remain in their collapsed conformation and sterically hinder the enzyme from becoming sufficiently close to their respective luminophore groups for their redox state to be altered. Thus the effect of the probe 13 in stretching the carrier oligonucleotides of the unit is to write-enable the luminophore groups carried by the stretched carrier oligonucleotides prior to the washing with the redox-state-altering enzyme.

Subsequently, the enzyme is removed from the medium 1, for example by washing, and the probe 13 is moved away from the unit, allowing the carrier oligonucleotides 3 in the unit to return to their collapsed conformation. In this way, only the luminophore groups 10 of that unit in the array are switched to the inoperative state in order to encode information.

It is to be appreciated that with respect to the embodiments of the invention that write information by altering the redox state of luminophore groups 10, the process of writing may be reversed in order to provide a re-writable data storage medium 1. This can be achieved by, for example, washing the medium with a further redox-state-altering enzyme, which switches the luminophore groups 10 to their original, operative redox state.

With further reference to the second technique for writing information, a process of photobleaching may be used to write information. In one embodiment, the luminophore groups 10 on the medium 1 are all initially provided in an operative state. In order to write information to the luminophore groups 10 of a carrier oligonucleotide 3, the carrier oligonucleotide is stretched, for example, by using the probe 13 or by exposing the units of the array to an electric field, that is, in order to write-enable the luminophore groups 10. Subsequently, high intensity light of a particular wavelength is shone on the luminophore groups and those luminophore groups responsive to the wavelength of light are “bleached” switching them to the inoperative state, in response to incident light. Luminophore groups on carrier oligonucleotides that are unstretched by the probe 13 or the electric field are unaffected by the high intensity light. In another of these embodiments in which each carrier oligonucleotide 3 has attached to it quencher groups 8 that absorb incident light. The luminophore groups 10 on the medium 1 are all initially provided in an operative state. In order to write information to the luminophore groups 10 of a carrier oligonucleotide 3, the carrier oligonucleotide is stretched using the probe 13 in order to write-enable the luminophore groups 10. Subsequently, high intensity light of a particular wavelength is shone on the luminophore groups and those luminophore groups responsive to the wavelength of light are “bleached” switching them to the inoperative state, in response to incident light. Luminophore groups on carrier oligonucleotides that are unstretched by the probe 13 are unaffected by the high intensity light. Because the photo-bleaching process may cause some bleaching of these quencher groups 8, in certain embodiments between 10 and 100 quencher groups 8 absorbing incident light are attached to each carrier oligonucleotide 3 and between 1 and 5 quencher groups 8 absorbing light emitted by the luminophore groups 10 are attached to each carrier oligonucleotide. In some embodiments, the physico-chemical environment of the luminophore groups is altered during illumination under high intensity light to enhance the rate of photo-bleaching. This is achieved by altering the temperature or pH of the medium or by the addition of chemicals.

In order to read information from the data storage medium 1 the probe 13 is located adjacent (in the order of 10 nm to 10 μm) a readable unit 10 of carrier oligonucleotides 3. The positive electrical charge on the probe 13 attracts the carrier oligonucleotides 3 of the readable unit 15 because of the intrinsic negative charge of a DNA oligonucleotide.

The attractive force caused by the probe 13 results in an alteration of conformation and a stretching of the carrier oligonucleotides 3 in the readable unit 15, as shown in FIG. 1, such that the luminophore groups 10 are no longer adjacent the quencher groups 8 (i.e. separated therefrom by a distance of approximately 50 nm to 1000 nm.) This causes the stretched carrier oligonucleotides 3 to have readable luminophores 10 because illumination by the light beam 12 results in emission of radiation 16 by the acceptor groups of the luminophores 10, in accordance with the properties of the particular luminophore groups. Thus luminophore groups 10 are only responsive to incident light when they are attached to carrier oligonucleotides 3 in the stretched, readable conformation, caused by the proximity of the electrically charged probe 13. The emitted radiation 16 is detected by a detector 17 from which the data encoded in the readable unit 15 can be determined. Subsequently, the probe 13 is moved relative to the array, causing the carrier oligonucleotides 3 of the previously readable unit 15 to collapse and become inactive and unreadable. The probe 13 stretches the carrier oligonucleotides 3 of another unit of the array into the readable conformation.

It is to be appreciated that the effect of the electrically charged probe 13 on the conformation of the carrier oligonucleotides 3 takes place on an extremely small area of the medium of less than 10 nm×10 nm (i.e. 100 nm²). Accordingly, the readable unit 15 of carrier oligonucleotides 3, being only a few nanometres across, may have its conformation changed from its inactive state to its readable state by the probe 13 even though the illuminating light 12 is over a greater area, including other units in the array. Thus the resolution of data storable in the embodiment is greater than is otherwise possible, being defined by the area of a unit whose conformation is influenced by the probe 13 (the resolution being in the order of nanometres rather than micrometres). This allows data storage densities of several thousand Mb per mm² if each unit of the array encodes only a single bit of data.

In some other embodiments of the invention, the change in conformation of the carrier oligonucleotides 3 of each unit of the array caused by the probe 8 comprises a flip, fold or rotation of the DNA oligonucleotides instead of the above described example of a stretch of the oligonucleotides. However, the effect of the conformational change is the same, namely to increase the distance in the affected oligonucleotides between the luminophore groups 10 and the quencher groups 8 such that the luminophore groups 10 are no longer quenched by the quencher groups 8 and are responsive to incident light.

In other embodiments of the invention, a polymer other than a DNA oligonucleotide may be used to carry the luminophore groups 10 and quencher groups 8. In particular, RNA oligonucleotides, polypeptides or organic polymers may be used instead. Indeed, in some embodiments, an elongate molecule other than a polymer is provided. A particular advantage in using polypeptides as the polymers is that the movement of the polypeptides under the influence of the probe 13 can be manipulated by selecting the amino acids that form the polypeptide. In particular, by selecting amino acids that form specific secondary structures, the movement of the polypeptide can be controlled. For example, if the polypeptide forms an α-helix then it is suited to a stretching movement under the influence of the probe 13. Alternatively, if the polypeptide forms a β-sheet then it will perform a flipping movement under the influence of the probe 13. Furthermore, if the polypeptide includes amino acids that form a flexible loop then the polypeptide performs a rotation under the influence of the probe 13.

It is to be appreciated that for carrier polymers that lack an intrinsic electrical charge, or whose charge is insufficient to be moved by the influence of the probe 13, charged groups may be added to the polymer in order to aid the electrostatic interaction with the probe 13. In certain embodiments, a dipole is created across the polymer by the addition of charged groups in order to provide the correct movement of the polymer under the influence of the probe 13.

In some embodiments, particularly in embodiments in which the polymer is not a nucleic acid, the quencher group 8 and luminophore groups 10 are attached to the polymer covalently instead of by an attachment oligonucleotide. Furthermore, if RNA oligonucleotides are used for the carrier oligonucleotides then the attachment oligonucleotides 9 can also be RNA oligonucleotides and an RNA duplex is formed on binding.

It is to be understood, that in some other embodiments of the invention, the probe 13 may not have a positive DC electrical charge. In particular, in certain embodiments, the probe has an AC charge with a frequency of between 10 Hz and 10 MHz preferably between 1 kHz and 1 MHz. These embodiments have the advantage that the AC charge untangles DNA as well as stretching it. In embodiments in which the polymer is positively charged, the probe 13 may have a negative DC electrical charge, in order to attract the polymer.

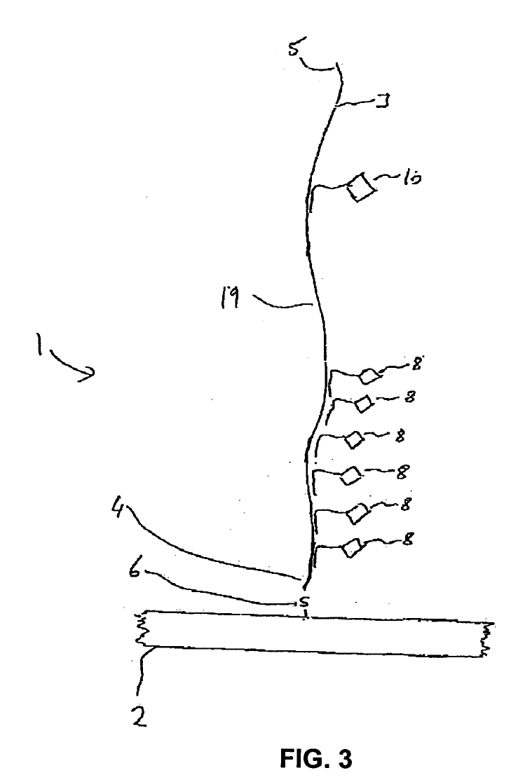

In the embodiments of the invention described thus far, a single quencher group 8 or a pair of quencher groups 8 are generally provided on each carrier oligonucleotide 3 in order to quench the effect of the luminophore group or groups 10 also carried by the carrier oligonucleotide. This allows a precise technique for the quenching of the luminophore groups when the carrier oligonucleotides 3 are in the collapsed conformation. However, in other embodiments, a statistical technique for quenching luminophore groups is used. Referring to FIG. 3, a portion of a data storage medium 1 is shown in accordance with such an alternative embodiment. As in the previous embodiments, a substrate 2 is provided on which are bonded an array of single-stranded carrier oligonucleotides 3 (one of which is shown). Six quencher groups 8 are attached to the carrier oligonucleotide 3, adjacent its first end 4, via attachment oligonucleotides 9. Further along the carrier oligonucleotide 3, in the direction of its second end 5, a luminophore group 10 is provided, attached to the carrier oligonucleotide 3 via an attachment oligonucleotide 9. Thus moving from the first end 4 to the second end 5 of the oligonucleotide 3, a region of quencher groups 8 is provided, followed by a distinct spacer region 19, followed, in turn, by a coding region comprising the luminophore group 10. The region of quencher groups 8 of the carrier oligonucleotide 3 and the other carrier oligonucleotides in the medium 1 form a layer of quenching activity in which the luminophore groups 10 are located on carrier oligonucleotides 3 in the collapsed conformation.

Thus, in these embodiments, when a unit is in an inactive state and its carrier oligonucleotides 3 are in the collapsed conformation, it is not necessary that each luminophore group 10 be adjacent its respective quencher group 8. This is because a sufficient number of luminophore groups 10 in the unit adjacent quencher groups 8 attached to other carrier oligonucleotides 3 bonded to the substrate 2, and will be quenched in the layer of quenching activity. Thus the combined effect of the luminophore groups 10 in response to incident light will be sufficiently reduced that any response will be identifiable as “noise” and therefore ignored. In this embodiment of statistical quenching, it is preferred that between 5 and 10 quenching groups be provided for each luminophore group.

In some embodiments of the invention, different types of luminophore group 10 are distinguishable by their emission of light having varying optical properties other than the wavelength of light emitted. For example, different types of luminophore group 10 emit light having a different intensity or polarisation in response to incident light. In certain embodiments, a mixture of luminophore groups 10 responsive to different optical properties are provided in the same data storage medium in order to encode data. In these embodiments, an even larger amount of information may be stored in each unit of the array. For example, in an embodiment in which there are four different types of luminophore group, each emitting a different wavelength of light, and each type of luminophore group can be provided in one of four intensities then every unit of the array encodes 256 bits of information—that being the number of combinations of types and intensities of luminophore groups.

In the above embodiments a single optical system 11 and probe 13 are provided. However, in other embodiments, a plurality of optical systems 11 and probes 13 are provided, operating simultaneously, to read different units of the data storage medium 1 in parallel. This allows for increased speed of reading data from the medium. Furthermore, in some embodiments in which different types of luminophore are provided, responsive to different wavelengths of light and/or different optical properties, multiple optical systems 11 are provided for each probe 13, each optical system directing radiation, such as laser light, of a different wavelength and property, appropriate to the luminophore groups in the medium 1.

In still further embodiments of the invention, the electrically charged probe 13 is substituted with a probe capable of changing the conformation of carrier oligonucleotides 3 in a unit of the array using a different physical phenomenon. For example, instead of the electronically charged probe 13, a probe influencing the conformation of carrier polymers by magnetic force may be provided. In embodiments in which carrier polymers are provided that are not intrinsically moveable under the influence of a magnetic field (such as DNA oligonucleotides), one or more magnetic beads are attached to the second end 5 of the carrier polymer. The magnetic beads have a diameter of between about 2 and 5 nm and allow the carrier polymer to be moved under the influence of a magnetic field.

In yet further embodiments of the invention, exemplified by the carrier oligonucleotide 18 of FIG. 1, quencher groups 8 are not provided on the carrier oligonucleotides 3. Instead the quencher groups 8 may be provided on separate carrier oligonucleotides from those carrying the luminophore groups 10. In these embodiments, it is preferable that the separate carrier oligonucleotides are not electrically charged and so are not moved by the influence of the probe 13. In other embodiments, quencher groups 8 are attached to the substrate 2, itself.

In some alternative embodiments, quencher groups 8 are not provided. Instead, the substrate 2 is made from a material such as a metal, in particular gold, which has quenching properties. The luminophore groups 10 are still inactivated when spacially adjacent the substrate 2 which has a quenching effect and therefore operation of the data storage medium 1 is very similar to the previous embodiments. In the embodiments, there is complete quenching when the luminophore groups are less than about 5 nm from the substrate 2. At a distance of greater than 50 nm, there is almost no quenching and therefore the luminophore groups are at least this distance from the substrate 2 when the carrier oligonucleotide 3 to which they are attached is in the readable conformation.

In another embodiment in which quencher groups 8 are not provided on the carrier oligonucleotides, an upper encapsulating surface is instead located above the carrier oligonucleotides. The surface either has intrinsic quenching qualities or carries separate quencher groups. When the carrier oligonucleotides are at rest, their respective luminophore groups 10 are quenched by their proximity to the upper encapsulating surface. In order to activate the luminophore groups 10 in a unit of the medium 1, the probe 13 is negatively charged and located adjacent the carrier oligonucleotides 3 of the unit. This has the effect of repelling the carrier oligonucleotides 3 and their luminophore groups 10 from the upper encapsulating surface so that the luminophore groups 10 are no longer quenched by the upper encapsulating surface. In order to inactivate the luminophore groups 10 again, the probe 13 is moved away from the unit so that the carrier oligonucleotides 3 return to their original position, with the luminophore groups 10 adjacent the quenching effect of the upper encapsulating surface.

In some embodiments in which no quencher groups 8 are provided, the luminophore groups 10 are not inactivated by quenching at all. Instead, the conformation of the carrier oligonucleotide itself can inactivate the luminophore groups 10. For example, in one embodiment the collapsed conformation of the carrier oligonucleotides 18 results in the luminophore groups 10 attached thereto being substantially unresponsive to light. This occurs because a collapsed carrier oligonucleotide 18 obscures its attached luminophore groups 10, preventing incident light 12 from reaching the luminophore groups 10 and/or preventing any emitted radiation 16 from being detected. In these embodiments, when the carrier oligonucleotides 18 are stretched into the readable conformation, the carrier oligonucleotides 18 cease obscuring their attached luminophore groups 10, allowing the luminophore group 10 to be responsive to incident light 12.

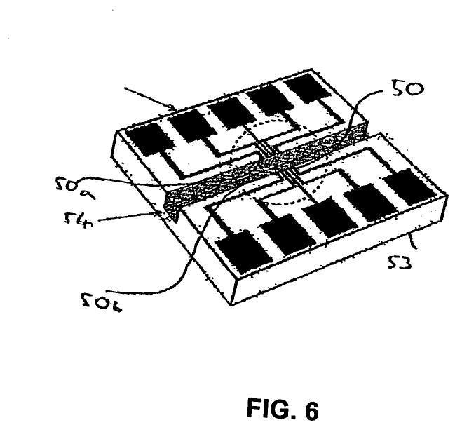

As illustrated in FIG. 6, a data storage medium in accordance with a fourth embodiment of the present invention, which also does not require quencher groups, includes a wafer 53 upon which is provided the substrate in the form of a plurality of sets of opposite facing electrodes 50, each set separated by a channel or groove 54. In this embodiment, the elongate carrier molecules are anchored to the electrodes i.e. the substrate; each electrode in effect providing a unit of the array. As will be appreciated, probe 13 can be dispensed with, since it is an electric field generated or applied between opposing electrodes 50a and 50b which cause the elongate carrier molecules to move from an unreadable and unwritable to a readable and writable conformation.

A specific data storage medium in accordance with a fourth aspect of the invention was constructed as follows:

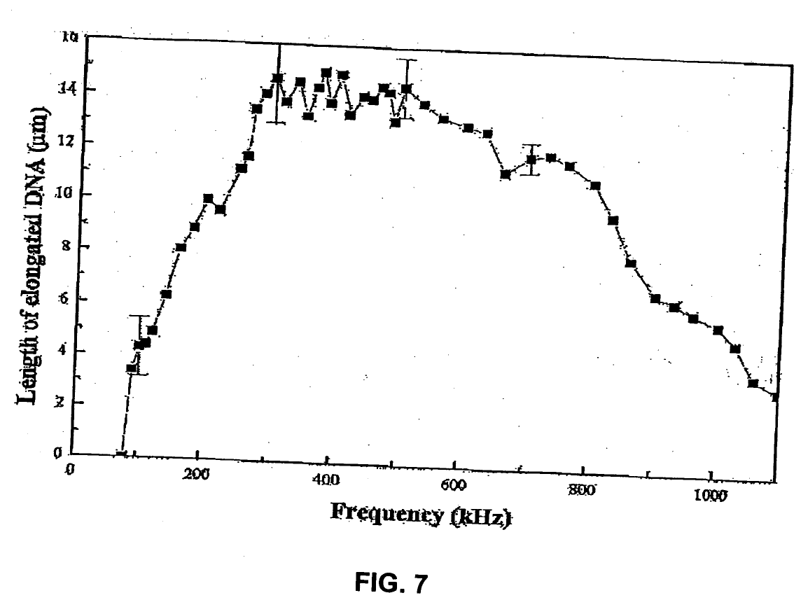

A series of electrodes were fabricated on a Si/SiO₂ wafer using standard UV photolithography, metal evaporation, and lift-off. The electrodes comprised a 35-nm-thick gold layer on a 10-nm-thick Ni/Cr adhesion layer and formed an opposing finger array pattern (see FIG. 7). The electrodes were 10 μm wide and 15 μm apart with a 20 μm or 30 μm gap between the tips of opposing electrodes. Following a second UV photolithography step, the 500-nm-thick SiO₂ layer between the opposing electrodes was removed using buffered HF for 8 min. The remaining SiO₂ layer was subsequently used as an etch mask to produce a 20-μm-deep groove in the underlying silicon layer by immersing the wafer in a KOH/propanol/H₂O solution for 25 min at 78° C. and rinsing with deionised water. Prior to use, the wafer was cleaned by soaking in ‘piranha’ solution (30% H₂O₂, 70% H₂SO₄) for 1 h, rinsed in deionised water, ethanol, in deionised water again, and finally air-dried. It has been reported that DNA can bind onto glass surfaces and so to prevent this, especially after the DNA is stretched, the exposed SiO₂ surface was blocked by immersion in a 1:5 v/v solution of trimethyl chlorosilane in tetrachloroethane for 1 h (see Braun E, Eichen Y, Sivan U and Ben-Yoseph G 1998 Nature 391 775; the contents of which are herein incorporated by reference thereto) after cleaning. The sample was then rinsed three times with tetrachloroethane, followed by isopropanol, and thoroughly air-dried. All chemical reagents were purchased from Sigma, unless otherwise noted.

The electrode was then coated with fluorescently-labelled λ-DNA using the multistep immobilisation procedure outlined above.

As regards writing information to this data storage medium this can be done by photobleaching the fluorescent DNA attached to specific selected electrodes, following dielectrophoretic elongation of the selected DNA “bit”, that is, on applying an electric filed between opposing electrodes. In this connection, only the fluorophores intercalated into the DNA molecules reaching the laser beam will be photobleached and subsequently detected on reading. Our investigations established that an electric field of 1 MV/m at 400 kHz was preferable to ensure that the DNA orientated into the groove was maximally elongated (see FIG. 7).

As outlined above, it is preferable that the molar ratio of intercalator to base pairs is 1:8. In this connection, the YOYO-1 fluorophores can be bisintercalated into the base pairs of the DNA [for example see Kanony C, Akerman B and Tuite E 2001 J. Am. Chem. Soc. 123 7985 the contents of which are herein incorporated by reference thereto], and are photolyzed by .OH radicals when illuminated with intense light causing single-stranded breakage of the DNA.

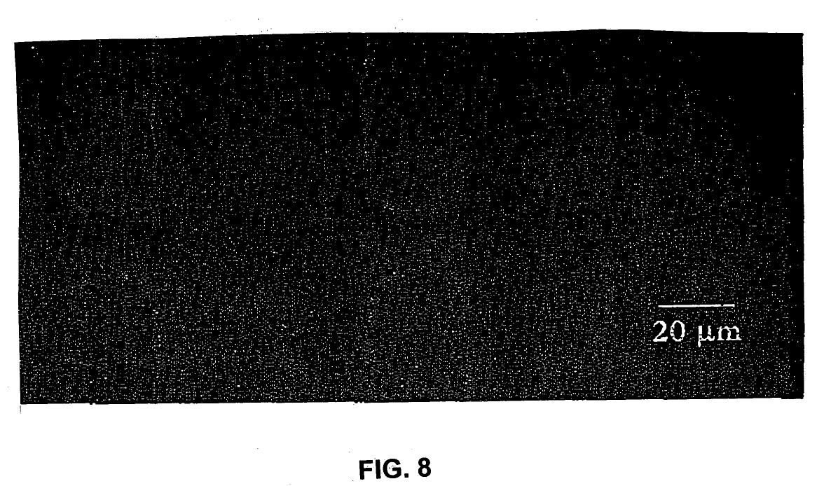

As illustrated in FIG. 8 an array of five electrodes 50 is shown in which the fluorescently-labelled λ-DNA on the first and third electrodes have been simultaneously orientated and elongated in preparation to being photobleached for 30 min in the 10 mW laser beam. This will write a binary 10100, where a photobleached electrode corresponds to a binary ‘1’, and a fluorescent electrode corresponds to a binary ‘0’, that is, when read sequentially.

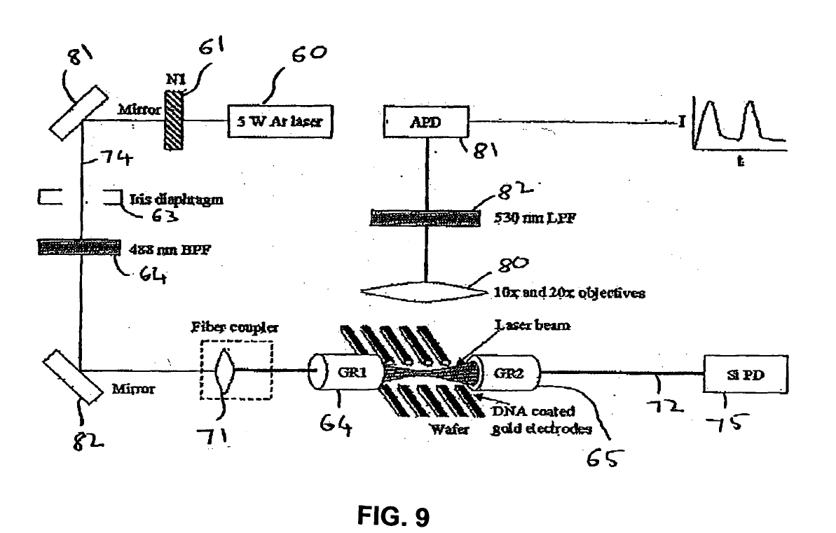

An optical system suitable for reading and writing the data storage means of this fourth embodiment of the invention is illustrated in FIG. 9. Such optical system includes a source of radiation, namely, an argon ion laser 60, a transmission neutral density filter (N1 or 61), an iris diaphragm 63 and a band pass filter (BPF or 64) coupled to a multimode fibre 71 (0.48 numerical aperture). At the far end of the fibre 71, a 0.29 pitch gradient-index micro lens (GR1 or 64) is provided together with a second 0.29 pitch gradient-index micro lens (GR2 or 65), the latter being coupled to a second optic fibre 72. The optical system also comprises a plurality of mirrors 81, 82.

In use, the beam 74 of the 5 W argon ion laser 60 is attenuated with the 1% transmission neutral density filter (N1 or 61), and scattered light excluded with the iris diaphragm 63. The 488 nm line (selected to correspond to the absorption maximum of the fluorophores at 491 nm) is isolated with a band pass filter (BPF or 64) and coupled into the multimode fibre 71 (0.48 numerical aperture). The 0.29 pitch gradient-index micro lens (GR1) 64, at the far end of the fibre 71, focuses the beam of radiation, laser light, into the groove 54 between the sets of oppositely facing electrodes 50a and 50b on the wafer 53. As will be appreciated, the wafer 53 can be mounted on a high-precision XYZ and rotation stage to aid alignment. The second 0.29 pitch gradient-index micro lens (GR2) 65 then couples the light emerging from the groove 54 into the second optic fibre 72 for detection by a PIN photodiode 75 for alignment purposes. In use, the gradient index lenses 64, 65 and the wafer 53 with its DNA were submerged in deionised water (conductivity 5 μS/m).

The optical system further includes a detector. In this illustrated embodiment, fluorescence from the YOYO-1 is collected by a microscope 80 type combination of a 20× objective and a 10× eyepiece mounted above the wafer 53, and the intensity quantified with a silicon avalanche photodiode 81 (APD) operated at room temperature at a reverse bias of 230 V. A 530 nm long pass filter 82 (LPF) can be used to eliminate any scatter of the incident beam.

Dielectrophoretic stretching of the λ-DNA on the electrodes can be achieved by applying an oscillating bias across two opposite electrodes (one grounded) using a 20 kHz-1.1 MHz signal generator. All other electrodes were left at a floating potential. The electric field referred to herein is the applied peak potential difference divided by the width of the gap between opposing electrodes.

As will be appreciated, the reading procedure applicable to this embodiment involves the step of briefly elongating the λ-DNA on each electrode sequentially into the laser beam and measuring the fluorescence intensity. A reduced laser power of 1 mW was preferred.

Although this fourth embodiment has been described by way of reference to the use of a fluorophore as the luminescent species, it is to be understood that the carrier molecules can carry other forms of luminiphores. In this connection, the reading and writing modes applicable would be adapted accordingly, that is, depending on the form of radiation being emitted thereby.

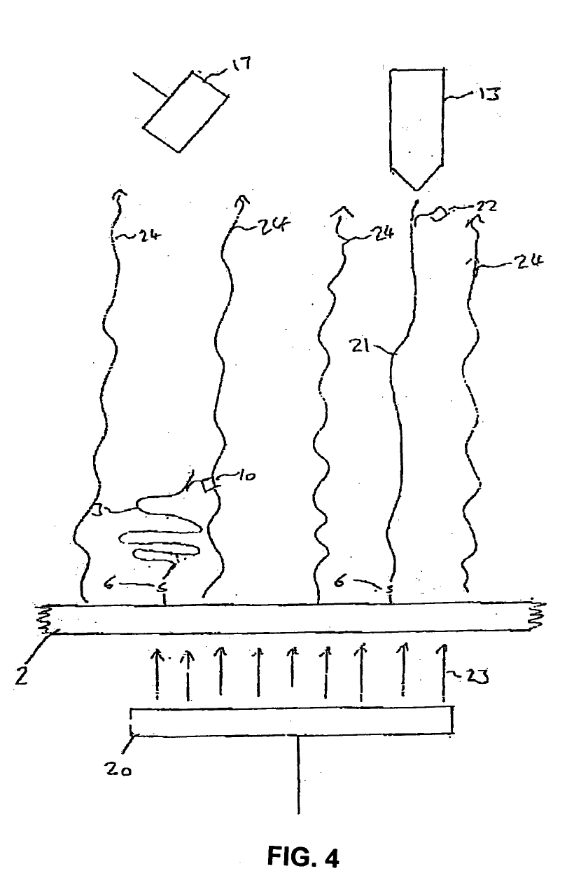

Referring to FIG. 4, an alternative embodiment of the invention is shown in which like components from the previous embodiment are labelled with the same numbers. Accordingly, a substrate 2, having quenching properties, is provided to which is bonded an array of carrier oligonucleotides 3. The oligonucleotides 3 each carry a luminophore group 10, attached to the carrier oligonucleotides as described in relation to the previous embodiments. The luminophore groups 10 are quenched when adjacent the substrate but no quencher groups are provided in this embodiment. A probe 13 is provided, above the array. It is movable relative to the array and has a positive electric charge. A radiation detector 17 is also provided above the array. An evanescent field emitter 20 is located beneath the substrate 2.

In order to read data from the medium 1 of this embodiment, the probe 13 is located adjacent the carrier oligonucleotide 21 of the unit which is to be read. Because the probe has a positive electric charge, it attracts the adjacent carrier oligonucleotides 21 such that the luminophore group 22 attached to the attracted carrier oligonucleotide 21 is between 20 and 100 nm from the surface of the substrate 2. Thus the probe 13 attracts the adjacent oligonucleotides 21 into the readable conformation. The luminophore groups 10 attached to carrier oligonucleotides 3 at rest in the collapsed conformation are less than 5 nm from the substrate and thus are quenched by the substrate. An evanescent field 23 is emitted towards the underside of the substrate 3 by the evanescent field emitter 20. This induces an area of surface plasmons 24 on the top surface of the substrate 2. The luminophore group 22 that is attached to the carrier oligonucleotide 21 in the readable conformation is excited by the surface plasmons 24 and emits radiation that is detected by the detector 17. However, the luminophore groups 10 attached to carrier oligonucleotides 3 in the collapsed conformation are quenched due to their proximity to the substrate 2. Thus even though the effect of the evanescent field 23 may be over a relatively large area, encompassing several units of the array, there is only emission of radiation from the luminophore groups attached to the carrier oligonucleotides 21 stretched into the readable conformation. Consequently data is read from a single unit of the array. Plasmon energy density decreases with distance from the substrate 2. Thus the luminophore group 22 must not be too far away from the substrate 2 when the carrier oligonucleotide 21 to which it is attached is in the readable conformation because otherwise the energy of the surface plasmons is insufficient to excite the luminophore group 22. Consequently the range of 20 to 100 nm is the optimal distance from the substrate for luminophore groups 22 attached to carrier oligonucleotides 21 in the readable conformation, the distance being neither too close to the substrate to result in quenching of the luminophore group nor too far from the substrate for the surface plasmons to affect the luminophore group.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

The principles, preferred embodiment and modes of operation of the present invention have been described in the foregoing specification. This invention which is intended to be protected herein, however, is not to be construed as limited to the particular forms disclosed, since there are to be regarded as illustrative rather than restrictive. Variations and changes may be made by those skilled in the art without departing from the spirit of the invention.

1. A data storage medium comprising: a substrate; and a plurality of elongate carrier molecules anchored to the substrate, each carrier molecule carrying one or more luminescent groups and being alterable between a readable conformation in which the luminescent groups carried by the molecule are able to emit radiation and an inactive conformation in which the luminescent groups carried by the molecule are inhibited from emitting radiation.

2. A data storage medium according to claim 1, wherein each of the plurality of elongate carrier molecules is associated with one or more quencher groups located such that when each molecule is in the inactive conformation, the or each quencher group renders the luminescent group of the molecule inactive.

3. A data storage medium according to claim 2, wherein the distance between the or each quencher group and each luminescent group carried by the associated elongate carrier molecule when in the readable conformation is at least 50 nm.

4. A data storage medium according to claim 2, wherein the distance between the or each quencher group and each luminescent group carried by the associated elongate molecule when in the inactive conformation is less than 50 nm.

5. A data storage medium according to claim 2 wherein, the or each quencher group is carried by its associated elongate carrier molecule.

6. A data storage medium according to claim 5, wherein the quencher groups are provided substantially adjacent the substrate.

7. A data storage medium according to claim 5 wherein the elongate carrier molecules are carrier oligonucleotides and the or each quencher group is attached to its respective carrier oligonucleotide via an attachment oligonucleotide having a sequence complementary to a sequence of the respective carrier oligonucleotide.

8. A data storage medium according to claim 2, wherein the or each quencher group is carried by the substrate.

9. A data storage medium according to claim 2, wherein fewer than ten quencher groups per luminescent group are associated with each elongate, carrier molecule.

10. A data storage medium according to claim 9, wherein one or two quencher groups per luminescent group are associated with each elongate, carrier molecule,

11. A data storage medium according to claim 9, wherein five to ten quencher groups per luminescent group are associated with each elongate, carrier molecule.

12. A data storage medium according to claim 2, wherein at least one of said one or more quencher groups is able to quench incident light on adjacent luminescent groups when their associated elongate, carrier molecule is in the inactive conformation.

13. A data storage medium according to claim 2, wherein at least one of said one or more quencher groups is able to quench light from being emitted from adjacent luminescent groups when their associated elongate, carrier molecule is in the inactive conformation.

14. A data storage medium according to the preceding claim 1, wherein the substrate has luminescent group quenching properties such that when the elongate, carrier molecule is in the inactive conformation, the substrate renders inactive the luminescent group or groups carried by the molecule.

15. A data storage medium according to claim 1, wherein the substrate is made from a metal.

16. A data storage medium according to claim 15, wherein the metal comprises gold.

17. A data storage medium according to claim 1, wherein the conformation of the elongate, carrier molecule in the inactive conformation inhibits the luminescent group or groups carried by the molecule.

18. A data storage medium according to claim 1 wherein the substrate is a plasmon transmitting substrate.

19. A data storage medium according to claim 18 wherein said one or more luminescent groups are located less than 5 nm from the substrate when their respective elongate carrier molecule is in the inactive conformation.

20. A data storage medium according to claim 18 wherein said one or more luminescent groups are located between 20 and 100 nm from the substrate when their respective carrier molecule is in the readable conformation.

21. A data storage medium according to claim 1, wherein the elongate, carrier molecules are carrier polymers.

22. A data storage medium according to claim 21, wherein the carrier polymers are organic carrier polymers.

23. A data storage medium according to claim 22, wherein the carrier polymers are carrier oligonucleotides.

24. A data storage medium according to claim 23, wherein the carrier oligonucleotides are carrier DNA oligonucleotides.

25. A data storage medium according to claims 23, wherein said one or more luminescent groups are attached to their respective carrier oligonucleotide via an attachment oligonucleotide having a sequence complementary to a sequence of the respective carrier oligonucleotide.

26. A data storage medium according to claim 23, wherein each carrier oligonucleotide is anchored to the substrate by an intermediating linker oligonucleotide, the linker oligonucleotide being anchored to the substrate and comprising a nucleotide sequence complementary to a sequence of the carrier oligonucleotide such that said sequences form a duplex, binding the carrier oligonucleotide to the linker oligonucleotide.

27. A data storage medium according to claim 22, wherein the organic carrier polymers are carrier polypeptides.

28. A data storage medium according to claim 27, wherein said polypeptide comprises an α-helix domain.

29. A data storage medium according to claim 27, wherein said polypeptide comprises a β-sheet domain.

30. A data storage medium according to claim 27, wherein said polypeptide comprises a flexible loop.

31. A data storage medium according to claim 1, wherein each elongate, carrier molecule is movable between the readable and inactive conformations under the influence of an electric field.

32. A data storage medium according to claim 31, wherein the electric field is positive.

33. A data storage medium according to claim 31, wherein the electric field is negative.

34. A data storage medium according to claim 31 wherein the electric field is alternating.

35. A data storage medium according to claim 34, wherein the electric field alternates at a frequency of up to 10 MHz.

36. A data storage medium according to claim 34, wherein the electric field alternates at a frequency of from 10 kHz to 1 MHz.

37. A data storage medium according to claim 1, wherein each elongate, carrier molecule is movable between the readable conformation and the inactive conformation under the influence of a magnetic field.

38. A data storage medium according to claim 1, wherein the alteration of an elongate, carrier molecule between the inactive conformation and the readable conformation comprises a stretch, flip, fold or rotation thereof.

39. A data storage medium according to claim 1, wherein each elongate, carrier molecule carries a plurality of distinguishable luminescent groups.

40. A data storage medium according to claim 39, wherein each elongate, carrier molecule carries four distinguishable luminescent groups.

41. A data storage medium according to claim 1, wherein each elongate, carrier molecule carries one or more groups carrying an electrical charge.

42. A data storage medium according to claim 1, wherein said one or more luminescent groups each comprises one or more luminophores.

43. A data storage medium according to claim 1, wherein said one or more luminescent groups each comprises one or more semiconductor nanocrystals.

44. A data storage medium according to claim 1, wherein said radiation is visible radiation.

45. A data storage medium according to claims 1 wherein said radiation has a wavelength of from 0.70 to 1.5 μm.

46. A data storage medium according to claim 1 wherein said radiation has a wavelength of from 0.2 μm to 0.4 μm.

47. A writer for a data storage medium incorporating a plurality of elongate, carrier molecules each capable of carrying one or more luminescent groups and being alterable between a readable conformation and an inactive conformation, the writer comprising: a plurality of luminescent groups selectively attachable to each elongate, carrier molecule.

48. A writer according to claim 47, wherein the elongate, carrier molecules are carrier oligonucleotides and each luminescent group comprises an attachment oligonucleotide having a sequence complementary to at least a portion of the sequence of one or more of the carrier oligonucleotides.

49. A writer according to claim 47 further comprising a probe capable of effecting an alteration of one or more selected elongate, carrier molecules of the data storage medium from the inactive to the readable conformation, the luminescent groups being attachable to elongate, carrier molecules in the readable conformation but unattachable to elongate, carrier molecules in the inactive conformation.

50. A method of writing to a data storage medium incorporating a plurality of elongate, carrier molecules each capable of carrying one or more luminescent groups and being alterable between a readable conformation and an inactive conformation, comprising the steps of:
selectively attaching luminescent groups to each elongate, carrier molecule.

51. The method of claim 50, wherein the step of selectively attaching luminescent groups comprises activating a selected elongate, carrier molecule to increase the attachability of luminescent groups to the elongate, carrier molecule and providing luminescent groups to the medium such that they attach to the activated elongate, carrier molecule.

52. The method of claim 51, wherein the step of activating the selected elongate, carrier molecule comprises altering the molecule from its inactive to its readable conformation.

53. A writer for a data storage medium incorporating a plurality of elongate, carrier molecules each carrying one or more luminescent groups having a first operative state and being alterable between a readable conformation and an inactive conformation, the writer comprising:
a switch for switching the operative state of selected luminescent groups to a second operative state.

54. A writer according to claim 53 wherein in the first operative state the luminescent groups are operative and in the second operative state the luminescent groups are inoperative.

55. A writer according to claim 53, further comprising means for a write-enablor which can write-enable selected luminescent groups, the switch for switchin the operative state of selected luminescent groups being effective only on write-enabled luminescent groups.

56. A writer according to claim 55, wherein the write-enablor or writer for write-enabling selected luminescent groups comprises a probe capable of effecting alteration of one or more selected elongate, carrier molecules from the inactive to the readable conformation.

57. A writer according to claim 55, wherein the switch for switching the operative state of selected luminescent groups to a second operative state comprises a redox state altering enzyme.

58. A writer according to claim 55, wherein the switch for switching the operative state of selected luminescent groups to a second operative state comprises a photobleacher.

59. A writer according to claim 53 further comprising a switch for switching the operative state of selected luminescent groups to the first operative state.

60. A method of writing to a data storage medium incorporating a plurality of elongate carrier molecules, each carrying one or more luminescent groups having a first operative state and being alterable between a readable conformation and an inactive conformation, comprising the steps of:
selectively switching the operative state of selected luminescent groups to a second operative state.

61. A method according to claims 60 wherein in the first operative state the luminescent groups are operative and in the second operative state the luminescent groups are inoperative.

62. A method according to claim 60, further comprising the step of write-enabling one or more selected elongate, carrier molecules, prior to switching the operative state of the write-enabled molecules.

63. A method according to claim 62, wherein the step of write-enabling one or more selected elongate, carrier molecules comprises altering the molecule from the inactive to the readable conformation.

64. A method according to claims 60, wherein the step of switching the operative state of selected luminescent groups comprises altering the redox state, or quantum yield of the luminescent groups.

65. A method according to claim 64, wherein altering the redox state of the luminescent groups comprises providing a redox-state altering enzyme.

66. A method according to claim 64, wherein altering the quantum yield of the luminescent groups comprises providing a photobleacher.

67. A method according to claim 60 further comprising the step of selectively switching the operative state of selected luminescent groups to the first operative state.

68. A reader for a data storage medium incorporating a plurality of elongate, carrier molecules, each carrying one or more luminescent groups and being alterable between a readable conformation and an inactive conformation, the reader comprising:
a probe capable of effecting an alteration of one or more selected elongate, carrier molecules of the data storage medium from the inactive to the readable conformation.

69. A reader according to claim 68 further comprising:
a radiation source directable on the data storage medium; and
a detector for detecting radiation emitted by the luminescent groups.

70. A reader according to claim 69, wherein the radiation source is a light source, of visible radiation.

71. A reader according to claim 69, wherein the radiation source is a source of radiation having a wavelength of between 0.70 and 1.5 μm.

72. A reader according to claim 69, wherein the radiation source is a source of radiation having a wavelength of between 0.2 and 0.4 μm.

73. A reader according to claim 69, wherein the plurality of elongate, carrier molecules are anchored to a substrate and the radiation source comprises an evanescent field generator.

74. A reader according to claim 73, wherein the substrate is substantially planar, the plurality. of elongate, carrier molecules being anchored to one side of the substrate, and the evanescent field generator is directable on the other side of the substrate.

75. A reader according to claim 69, wherein the reader comprises a plurality of radiation sources and/or detectors.

76. A reader according to claim 68, wherein the reader comprises a plurality of probes.

77. A reader according to claim 68, wherein the or each probe is operable to carry an electrical charge.

78. A reader according to claim 77, wherein the electric charge is positive direct current.

79. A reader according to claim 77, wherein the electric charge is negative direct current.

80. A reader according to claim 77, wherein the electric charge is alternating.

81. A reader according to claim 80, wherein the electric charge alternates at a frequency of up to 10 MHz.

82. A reader according to claim 81, wherein the electric charge alternates at a frequency of from 10 kHz to 1 MHz.

83. A reader according to any one of claims 68 to 82, wherein the or each probe is capable of effecting alteration of the one or more selected carrier polymers from the inactive to the readable conformation over an area of less than 100 nm.

84. A method of reading a data storage medium incorporating a plurality of elongate, carrier molecules, each carrying one or more luminescent groups and being alterable between a readable conformation and an inactive conformation, comprising the step of effecting an alteration of one or more selected elongate, carrier molecules of the data storage medium from the inactive to the readable conformation.

85. A method according to claim 84 further comprising the steps of directing radiation on the one or more selected elongate, carrier molecules and detecting radiation emitted by the luminescent groups.

86. A method according to claim 84 or 85 wherein the step of effecting an alteration of one or more selected elongate, carrier molecules comprises stretching, flipping, folding or rotating the molecule.

87. The writer of claim 47, wherein the plurality of elongate carrier molecules are located on one or more sets of oppositely facing electrodes.

88. The writer of claim 53, wherein the plurality of elongate carrier molecules are located on one or more sets of oppositely facing electrodes.

89. A data storage medium of claim 1, in which the substrate is in the form of at least one set of oppositely facing electrodes.
